(19) United States
(12) Patent Application Publication
(10) Pub. No.: US 2008/0011983 A1
(43) Pub. Date: Jan. 17, 2008

(54) Liquid Crystal Composite and Device comprising the same

(75) Inventors: Wei Lee, Chung-Li (TW); Jia-Shiang Gau, Chung_Li (TW); Hui-Yu Chen, Chung-Li (TW)

Correspondence Address: WPAT, PC, 7225 BEVERLY ST., ANNANDALE, VA, 22003, US

(73) Assignee: CHUNG YUAN CHRISTIAN UNIVERSITY, Chung-Li (TW)

(21) Appl. No.: 11/457,458

(22) Filed: Jul. 14, 2006

(51) Int. Cl. C09K 19/52

(52) U.S. Cl. 252/299.01

(57) ABSTRACT

The present invention discloses a liquid crystal composite comprising a liquid crystal composition as a host and a plurality of carbon nanotubes as dopants, wherein the carbon nanotubes are dispersed in the liquid crystal composition. The average length of the carbon nanotubes is equal to or less than 1 μm. Additionally, this invention also discloses a device comprising the mentioned liquid crystal composite.

### BACKGROUND OF THE INVENTION

1. Field of the Invention

The present invention is generally related to a liquid crystal composite, and more particularly to a liquid crystal composition doped with carbon nanotubes and device comprising the same.

2. Description of the Prior Art

At present, a general liquid crystal cell constituting a flat panel display is manufactured in the following procedure. First, an electrode and an alignment film are successively formed on each of a pair of glass substrates having switching elements, a color filter layer, and the like. Subsequently, these glass substrates are disposed at a constant distance so that the alignment films are disposed opposite to each other, peripheries of the glass substrates excluding a liquid crystal sealing port are fixed with an adhesive, and a liquid crystal cell is formed. Additionally, a gap between the glass substrates is maintained to be constant by spacers. Thereafter, the gap between the liquid crystal cell is filled with a liquid crystal composition to form a liquid crystal layer, and the liquid crystal sealing port is sealed with a sealing material so that the liquid crystal cell is obtained.

For the liquid crystal cell manufactured by this method, the liquid crystal layer is often contaminated with impurity ions which may originate in the primitive cell materials or from cell manufacturing process, greatly influencing a display property. Because the contamination with the impurity cannot be avoided in conventional liquid crystal devices, a conventional liquid crystal display has a problem that display unevenness occurs and reliability is deteriorated.

### SUMMARY OF THE INVENTION

In view of the above background and to fulfill the requirements of industry, a new liquid crystal composite and device comprising the same are invented.

One subject of the present invention is to fabricate a liquid crystal host doped with a minute addition of carbon nanotubes. Comparing to the conventional neat liquid crystal composition, lower threshold dc or ac voltage Vₜₕ and lower driving voltage V_{d} can be both achieved in this invention. Therefore, the liquid crystal composite provided in this invention does have the economic advantages for industrial applications.

Another subject of the present invention is to provide a liquid crystal host doped with shortened carbon nanotubes. The shortened carbon nanotubes can avoid problems of entangling and aggregating, and play an important role to obtain good and stable dispersion in the liquid crystal composite.

Accordingly, the present invention discloses a liquid crystal composite comprising a liquid crystal composition as a host and a plurality of carbon nanotubes as dopants, wherein the carbon nanotubes are dispersed in the liquid crystal composition. The average length of the carbon nanotubes is equal to or less than 1 μm. Additionally, this invention also discloses a device comprising the mentioned liquid crystal composite.

### BRIEF DESCRIPTION OF THE DRAWINGS

FIG. 1 is transmittance vs. applied dc voltage and V-T hysteresis up to 8V according to example 1 of the present invention. The undoped cell, voltage up (▪) and down (□); C₆₀-doped cell, voltage up () and down (◯); CNT-doped cell, voltage up (▴) and down (Δ);

FIG. 2 is V-C hysteresis up to 8V according to example 1 of the present invention. The undoped cell, voltage up (▪) and down (□); C₆₀-doped cell, voltage up () and down (◯); CNT-doped cell, voltage up (▴) and down (Δ);

FIG. 3 is optical transmission upon electrical switching (a) on to 6 V and (b) off from 6 V according to example 1 of the present invention. The undoped cell, dotted line; C₆₀-doped cell, dashed line; CNT-doped cell, solid line;

FIG. 4 is the experimental setup of measurement of transient current according to example 2 of the present invention;

FIG. 5 is spatial distribution of the director orientation in the E7 cell according to example 2 of the present invention. The solid and dashed curves represent the steady director orientation in the presence of a negative (−6 V) and a positive (6 V) applied voltage, respectively;

FIG. 6 is transient currents induced by the polarity-reversed voltage of 1 V applied to an E7 cell, an E7/SWCNT cell and an E7/MWCNT cell at the room temperature according to example 2 of the present invention;

FIG. 7 is V-Iₚ characteristics of E7, E7/SWCNT, and E7/MWCNT cells according to example 2 of the present invention;

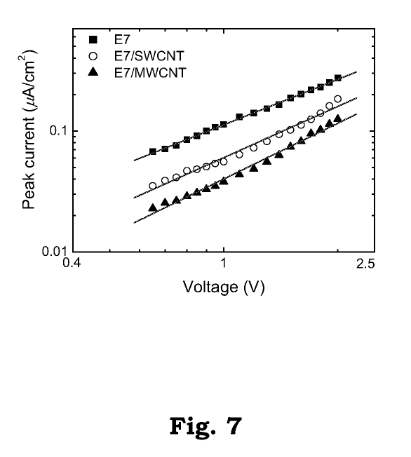

FIG. 8 is charge mobility as a function of voltage in a E7 cell, a E7/SWCNT cell, and a E7/MWCNT cell according to example 2 of the present invention; and

FIG. 9 gives spatial distribution profiles of the director orientation before and after the polarity reversal of 5 V in the E7 cell (black solid and dotted curves, respectively) and the E7/CNT cell (blue dashed and dash-dotted curves, respectively) according to example 2 of the present invention.

### DESCRIPTION OF THE PREFERRED EMBODIMENTS

What is probed into the invention is a liquid crystal composite and device comprising the same. Detailed descriptions of the composite composition and device structure will be provided in the following in order to make the invention thoroughly understood. Obviously, the application of the invention is not confined to specific details familiar to those who are skilled in the art. On the other hand, the common structures and elements that are known to everyone are not described in details to avoid unnecessary limits of the invention. Some preferred embodiments of the present invention will now be described in greater details in the following. However, it should be recognized that the present invention can be practiced in a wide range of other embodiments besides those explicitly described, that is, this invention can also be applied extensively to other embodiments, and the scope of the present invention is expressly not limited except as specified in the accompanying claims.

Over the last decade, a wide range of new nanoscale materials has been attracting a great deal of attention. Take carbon nanotubes for example, there are two main types of carbon nanotube with high structural perfection: single-walled carbon nanotubes (SWCNTs), which consist of a single graphite sheet seamlessly wrapped into a cylindrical tube, and multi-walled carbon nanotubes (MWCNTs), which comprise an array of concentric cylinders. SWCNTs and MWCNTs are usually produced by arc-discharge, laser ablation, chemical vapor deposition (CVD), or gas-phase catalytic process (HiPco) methods. Most frequently, the diameter of carbon nanotubes varies roughly between 0.4 nm and 3 nm for SWCNTs and from 1.4 nm to 100 nm for MWCNTs, and their typical dimensions are 5-100 μm in length.

Owing to the extraordinary structural, mechanical, and electronic properties of carbon nanotubes as well as of the lyotropic liquid crystallinity of MWCNTs in aqueous dispersion, carbon additives can widely be used as guest dopant in condensed optical materials to open a new era for photonic applications. In this invention, electro-optical properties of a NLC device were found to be modified by doping a minute addition of carbon nanotubes into the nematic liquid crystal host. In comparison with the characteristics of an undoped planar-aligned nematic cell, the experimental results indicate that planar nematic cells doped with MWCNTs possess a lower threshold dc voltage Vₜₕ as well as a lower driving voltage V_{d}. Moreover, the similar phenomenon is also observed in twisted-nematic cells doped with either single-walled or multi-walled carbon nanotubes.

However, the development of such composites meets some serious obstacles, as carbon nanotubes tend to phase segregate. In fact, carbon nanotubes do not spontaneously suspend in polymers or persistently suspend in liquid crystals, so the chemistry and physics of dispersion will play a crucial role. The challenge is particularly arduous: due to strong van der Waals interactions, nanotubes aggregate to form bundles or ropes of up to tens of nanometers in diameter for SWCNTs, which are very difficult to disrupt. Furthermore, these ropes are tangled with one another like spaghetti. With high shear, these ropes can be untangled, but it is extremely difficult to further disperse them at the single-tube level. For general carbon nanotube/polymer composite, this limitation can be overcome by introducing various functional groups on the carbon nanotubes surface that can help dispersion in the composite material. But as mentioned in the Prior Art, density of ionic impurity is a crucial matter for obtaining high-quality device performance in a liquid crystal display. Therefore, chemical modification for carbon nanotubes is not a sufficient solution of dispersing nanotubes in liquid crystal composition.

A better way provided in this invention to solve the problem is a combination of physical processes: “shorten the carbon nanotubes” and “agitate the shortened carbon nanotubes by high shear”. The shortening process prevents the carbon nanotubes, either pristine or surface-modified, from entangling and aggregating before them being used. Much better, the shortened carbon nanotubes play an important role to obtain good and stable dispersion after the following agitation process. Furthermore, in comparison with the display device containing un-shortened nanotube/liquid crystal composite, there is little probability that the shortened nanotubes connect with or align to each other to form a bridge between the positive and negative electrodes, which usually results in burned or damaged devices. Additionally, lowering the concentration of carbon nanotubes also decrease the formation of agglomerates.

In the first embodiment of the present invention, a liquid crystal composite is provided. The liquid crystal composite comprises a liquid crystal composition as a host and a plurality of carbon nanotubes as dopants, wherein the carbon nanotubes are dispersed in the liquid crystal composition, and more than 80% of the carbon nanotubes are dispersed at nanoscale level. The liquid crystal composition comprises calamitic (nematic, smectic, or their chiral phases) liquid crystal. Furthermore, the carbon nanotubes are single-walled, double-walled or multi-walled carbon nanotubes (CNTs). The average length of the carbon nanotubes is equal to or less than 1 μm. Additionally, the carbon nanotubes are at a concentration equal to or less than 0.1 wt % of the liquid crystal composite. At such low amount of loading well below the percolation limit (˜1% for highly anisotropic MWCNTs), one should expect each nanotube to act on its own, embedded in the liquid crystal medium and proving a very strong local anchoring to the liquid crystal director.

In the second embodiment of the present invention, a method for forming a liquid crystal composite is disclosed. First, a plurality of carbon nanotubes are provided. The carbon nanotubes are single-walled, double-walled or multi-walled carbon nanotubes (CNTs). Next, a grinding process is performed to separate and shorten the carbon nanotubes, so that the average length of the shortened carbon nanotubes is equal to or less than 1 μm. The shortened carbon nanotubes are then added into a liquid crystal composition to form a mixture. Finally, an agitation process is performed to agitate the mixture to form the liquid crystal composite, and more than 80% of the shortened carbon nanotubes are dispersed at nanoscale level.

Ball mills or roller mills can be used in the mentioned grinding process; especially, a Wig-L-Bug grinding mill is most recommended. The Wig-L-Bug grinding mill comprises a vial and two ball pestles, wherein the carbon nanotubes are ground by the ball pestles in the vial. For the purpose of reducing organic and metallic contamination, the preferred material of the vial and two ball pestles is selected from the following group consisting of: agate, silicon nitride, and zirconia. Agate is harder than steel, and chemically inert to almost anything except HF. It is also brittle and must be handled with care. Agate vials are for the grinding and mixing of samples when organic and metallic contaminations are equally undesirable. Agate is 99.9% silica and is extremely wear-resistant.

Silicon nitride is a tough space-age material with remarkable wear characteristics, and hardness superior to agate and zirconia. It is extremely durable compared to agate, and while it contains some yttria and alumina, overall contamination levels will be very, very low. Zirconia is ceramic which in many ways approaches the ideal grinding medium. Since it is both hard and tough it wears very slowly, adding little contamination. It is about one and one-half times as dense as alumina, grinding almost as fast as steel. And because it is mostly zirconium oxide with low percentages of magnesium oxide and hafnium oxide, the contamination zirconia ceramic does contribute is often not important to the analyst. Furthermore, the agitation process uses an apparatus selected from the group consisting of a high speed mixer, homogenizer, microfluidizer, a Kady mill, a colloid mill, a high impact mixer, an attritor, an ultrasonic bath, a ball and pebble mill, and combinations thereof.

In this embodiment, a liquid crystal device is provided. In addition to being applied in a display device, liquid crystal has been widely used in many electrically controlled tunable photonic devices, such as: a spatial light modulator, a wavelength filter, a variable optical attenuator (VOA), an optical switch, a light valve, a color shutter, a lens and lens with tunable focus. The mentioned liquid crystal device comprises a first electrode, a second electrode (at least one of the first and second electrodes being transparent), and the mentioned liquid crystal composite disposed between the electrodes, comprising (a) the liquid crystal composition as a host; (b) the mentioned shortened carbon nanotubes as dopants dispersed in the liquid crystal composition.

The foregoing paragraphs has described that the carbon nanotubes can connect with or align to each other to form a bridge between the positive and negative electrodes, which usually results in burned or damaged devices. To overcome the obstacle for liquid crystal devices with various thicknesses between electrodes, we suggest decreasing the average length of the shortened carbon nanotubes with decreasing the cell gap or distance between the first and second electrodes. For example:
(a) When the distance between the first and second electrodes ranges from 10 μm to 150 μm, the preferred average length of the shortened carbon nanotube is equal to or less than 1 μm;
(b) When the distance between the first and second electrodes is equal to or less than 10 μm, the preferred average length of the shortened carbon nanotube is equal to or less than 500 nm;
(c) When the distance between the first and second electrodes is equal to or less than 5 μm, the preferred average length of the shortened carbon nanotube is equal to or less than 200 nm.

Additionally, the carbon nanotubes are at a concentration equal to or less than 0.1 wt % of the liquid crystal composite, so as to decrease the formation of CNT agglomerates. Moreover, when the mentioned liquid crystal device is a display device, which is a direct addressing, a multiplexed, or an active matrix type TN (twisted nematic), HAN (hybrid-aligned nematic), VA (vertical alignment), planar nematic, STN (super-TN), OCB (optically compensated bend), TFT-TN mode liquid crystal display, or an IPS (in plane switching) mode or FFS (fringe field switching) mode liquid crystal display.

### EXAMPLE 1

In order to highlight the influence of a carbon dopant in its small quantity on the behavior of a nematic in terms of the ion-charge effects, we elect to use a representative low-resistivity (˜10¹¹ Ω·cm) LC driven by a dc voltage for this study. The voltage-transmittance (V-T) and voltage-capacitance (V-C) hystereses as well as the switching curves were obtained from undoped, C₆₀-doped and CNT-doped liquid crystal (LC) cells.

The sample fabrication approach was based on the concept of using liquid crystals to align carbon nanotubes parallel to the LC director. Empty cells were constructed from pairs of glass substrates separated by 5.7-μm ball spacers, yielding a cell gap of ˜6 μm. Both substrates in each pair were covered with indium-tin-oxide electrodes for application of an external dc field. The conducting substrates were then spin coated with polyimide to ensure a strong homogeneous alignment with a small tilt for our LC material. Assembly of each empty cell was accomplished to allow the directions of the rubbing on the substrates to be antiparallel to each other.

The guest-host LC material was prepared from a suspension of either ultra-pure-grade (>99.95%) fullerene C₆₀ or purified open MWCNTs (extract containing 90-95% nanotubes, of which 90% were uncapped at both ends) at a concentration of ˜0.01% by weight dispersed in the eutectic nematic E7. The CNTs we received consist of 18-25 concentric, cylindrical tubes of graphitic carbon with an average outer diameter of ˜10-20 nm and a length of 2-5 μm. It is worth mentioning that the fullerene C₆₀ is zero-dimensional and semiconducting (E_{g}=1.9 eV) and that the one-dimensional nanotubes we used are considered metallic (E_{g}=0). Prior to their dispersion and ultrasonication in LC, carbon nanosolids were pretreated with a Wig-L-Bug grinding mill composed of an agate vial and two agate ball pestles. Note that grinding helped prevent aggregation or physical entanglement and shortened the length of the CNTs. To manufacture doped LC cells, the colloidal solution was introduced into the empty cells by capillary action at an elevated temperature well above the clearing point of E7, T_{c}=58.6° C.

At low concentrations such as that adopted in this study, the clearing points of the suspensions were essentially not different from that of pure E7. Besides, compared with the counterparts filled with the neat LC, cells composed of either suspension were measured to possess the same value of the pretilt angle of 3.2±0.5° within experimental error. The low concentration allowed the suspended nanosolids to be effectively separated in the LC hosts. The stability of the cells consisting of doped LCs, in terms of their electro-optical performance, was examined to assure their lifetime of more than a year. Unlike LC colloids containing networks of polymeric particles, optical polarizing microscopy cannot be utilized to characterize the morphology of the blends. The LC colloids of carbon nanosolids behaved as a pristine LC with no evidence of dissolved or precipitated particles.

The experimental setup for electro-optical measurements was primarily composed of a conventional geometry where the planar-aligned LC cell was placed between two crossed linear polarizers, with its (undisturbed) optical axis oriented at 45° with respect to the polarization of a low-power 633-nm He—Ne laser probe beam. A power supply provided dc bias voltage across the sample thickness. Because of the positive dielectric anisotropy (Δε≡ε_{∥}−ε_{⊥>}0) of the nematic E7, an electric field parallel to the sample thickness tends to reorient the nematic director and, hence, the optical axis toward the field direction; namely, homeotropically. To measure the electric capacitance, a LCZ meter running a small ac voltage of 50 mV at 1 kHz was used. The entire experimental system was interfaced with a personal computer via LabVIEW.

### Results

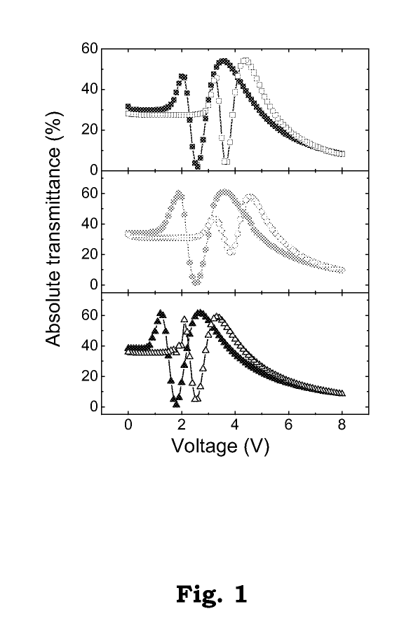

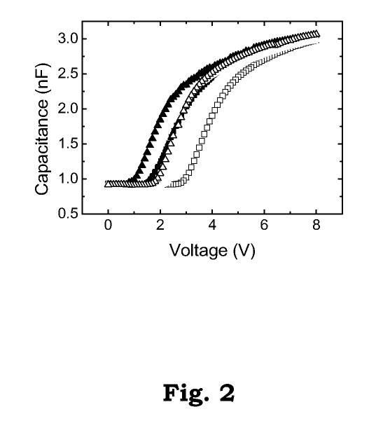

Each data point in both FIGS. 1 and 2 was taken 2 s after constant voltage was registered across the filled cell. To make it clear, the applied voltage increased step by step every two seconds up to 6 V and then decreased also step by step soon after with a measurement made at the end of each step. FIG. 1 shows the absolute transmittance as a function of the dc voltage applied upon various cells at room temperature. As reference measurements without a LC cell, the absolute transmittance was measured to be ˜65%, ˜50% and ˜0.02% through solely the linear polarizer with its transmission axis parallel to the polarization of the incident laser beam, the parallel polarizers and the crossed polarizers, respectively. The intensity of a probe beam traversing the polarizer-cell-analyzer system is given by

I_{⊥}∝I₀ sin² (δ/2), (1)

where I₀ denotes the incident polarized probe-beam intensity and δ stands for the phase retardation, which occurs due to the different propagating velocities of the ordinary and extraordinary rays in the cell. Note that the phase retardation can be calculated from the voltage-dependent transmitted intensity. The oscillations in FIG. 1 clearly show that a director reorientation takes place in a direction different from the probe-beam polarization, leading to both ordinary and extraordinary waves inside the LC. This reorientation results in a phase retardation of a multiple of π, with each integer multiple of π corresponding to an extremum of the voltage-dependent transmittance. With an understanding of Eq. (1), one identifies that the valley, i.e. transmission minimum, corresponds to a phase retardation of 2π while the plateau at null voltage corresponds to a phase retardation of ˜3.5π. The phase retardation can be expressed as

δ=2πd Δn/λ, (2)

where d (=5.7 μm), λ(=633 nm) and Δn (=0.220 at 633 nm by a cubic spline fit) denote the LC film thickness, probe-beam wavelength and effective LC birefringence, respectively. It is easy to show here that this formula gives the phase retardation near 4π for the cells under investigation in the absence of an applied voltage if the pretilt angle is ignored. Indisputably, the T(V) curve is very sensitive to the wavelength although it is chosen to be 633 nm in this study. If the threshold voltage Vₜₕ and the characteristic voltage V_{2π}, are defined as the voltages where the intensity transmitted is increased to 10% of the initial value at null voltage and decreased to the minimum, respectively, then it is clear from FIG. 1 that Vₜₕ(V_{2π})=1.6(2.6), 1.2(2.6) and 0.8(1.9) V for the undoped, C₆₀-doped and CNT-doped cells, respectively. Although the dc threshold voltage is distinct from the well recognized Fréedericksz threshold, Vₜₕ defined in this study is still presumably related to the first Oseen-Frank elastic constant K₁₁ and to the square root of the dielectric anisotropy Δε, i.e.

Vₜₕ∝\sqrt{K₁₁/ε₀Δε,} (3)

where ε₀ is the permittivity of free space. It is worth mentioning that, for a LC cell operating in the TN mode, Vₜₕ∝[(4K₁₁+K₃₃−2K₂₂)/ε₀Δε]^{1/2}, suggesting that the threshold of a TN cell is complicated by the involvement of all of the three Oseen-Frank elastic constants. Note that the effective dielectric anisotropy of the suspension can be approximated as

Δεₘᵢₓ≈(1−f)Δε_{LC}+fΔε_{CNT}, (4)

where f stands for the fraction of CNTs. The apparent decrease in Vₜₕ for the CNT-doped cell, to just half that for the undoped counterpart, is partially attributed to the large dielectric anisotropy (Δε>0) of the high-aspect-ratio nanotubes and to the parallel orientation of the nanotubes to the LC director based on continuum theories as well as experimental verification. Indeed, one can notice from FIG. 2 that the capacitance differences, when planar-aligned LC molecules are at rest (ε_{eff}≈ε_{⊥}) and are in the high applied dc field (ε_{eff}≈ε_{∥}), are distinct for the three types of cells. According to the relationship between the capacitance and the dielectric constant, one sees that CNT-doped E7 has to possess the smallest Vₜₕ because the tilt angles as well as the splay elastic constants are considered identical for these cells.

Owing to the field-screening effect, the above discussion with FIG. 2 can only be regarded as indirect evidence for the increase in dielectric anisotropy. To quantitatively verify the increase in the dielectric anisotropy, we conducted an independent experiment involving the transient current in a LC cell induced by the dc switch of a step voltage. Let us consider the one dimensional distribution of a nematic director n=(cos θ(t), 0, sin θ(t)) in a uniform electric field along the cell thickness, where θ(t) is the tilt angle between an alignment layer surface and the director. The effective dielectric constant ε_{eff}(θ(t)), given by

ε_{eff}(θ(t))=ε+Δεsin² θ(t), (5)

increases with increasing applied voltage V (>>Vₜₕ) due to the reorientation of the nematic director to minimize the total free energy. Using the concept of a parallel-plate capacitor, the dielectric anisotropy can be determined by the slope of the additional charge Q as a function of V in accordance with

Q=(ε₀Δε sin² θ)A/d ·V, (6)

where A is the area of the cell and d, again, is the cell gap. We obtained the value of Q by measuring transient current in a step voltage and then by integrating the transient current with time. The dielectric anisotropy of the CNT (0.05 wt. %) suspension was therefore measured via Δεₘᵢₓ=(Qₘᵢₓ/Q_{LC}) Δε_{LC}, giving a value of 1.1 times greater than that of the pure nematic E7. Because the Vth ratio of the CNT-doped cell to the undoped cell, estimated by (Δε_{LC}/Δεₘᵢₓ)^{1/2}, is only 0.95, the deduced reduction is so limited that it can hardly account for the dramatic decrease in dc threshold voltage observed in CNT-doped cells. With the experimental results obtained from our most recent study of electro-optical properties in CNT-doped cells driven by an ac voltage, we believe that the phenomena observed in this study are best explained by the involvement of CNTs as a dopant whose interaction with ion impurities permitted the thinness of the effective electric bilayers and, in turn, allowed the nematic molecules in the doped cell to experience a relatively higher effective external field for the same dc voltage applied and thus led to the subsequent lowering of the driving voltage assisted by the increased dielectric anisotropy. In other words, the most important contribution to the reduction of the dc threshold voltage was the suppression of the screening effect by the addition of CNTs dispersed in E7. This will be discussed later. It is likely that the carbonaceous additives, in spite of their trace amount, modified the LC/polyimide interface and thus lowered the anchoring strength. (The weak anchoring gives rise to a lower threshold based on Vₜₕ=π(K₁₁/ε₀Δε)^{1/2}/(1+2K₁₁/W_{θ}d), where W_{θ} is the polar anchoring energy.) Indeed, because the surface electric bilayers were explicitly associated with the surface-charge field, one could not undoubtedly say that the anchoring energy was not modified by the ion-binding process.

FIG. 1 also illustrates the V-T hysteresis due to the field-screening effect of the ion charges. It is worth mentioning that, with a constant field, the screening effect decreases continuously the field inside the LC. Thus, hysteresis must depend on the time (here 2 s) for which the constant voltage is applied and on the voltage difference between two measurements. Here, in FIG. 1, the hystereses at δ=2π are 1.1, 1.2 and 0.6 V for the undoped, C₆₀-doped and CNT-doped cells, respectively. Noticeably, the hysteresis of the CNT-doped cell reduces to nearly half that for the undoped one. It is obvious that the cell filled with the CNT suspension exhibits the smallest voltage offset, indicating that the CNT dopant detracts the severe ion-charge effects caused by residual ionic impurities in the neat nematic E7. As a matter of fact, the ion charges often originate in impurities in the LC itself or from foreign dopants. The screening effect, owing to the increased population of adsorbed ion charges on the interfaces under an applied dc voltage, results in a decrease of the effective voltage. Apparently, the C60-doped cell suffers from more severe field-screening effects as shown in FIG. 1.

FIG. 2 shows the capacitance variation in the undoped and doped cells. The capacitance of planar-aligned nematic cells rises with increasing voltage in that the nematic adopted has a positive dielectric anisotropy. This figure demonstrates that the V-C hysteresis of the CNT-doped cell is less serious than that of the undoped cell. Despite the relatively narrow hysteresis width of the C₆₀-doped cell in comparison with that of the undoped counterpart, the general behaviors revealed by FIG. 2 are consistent with the previous observation.

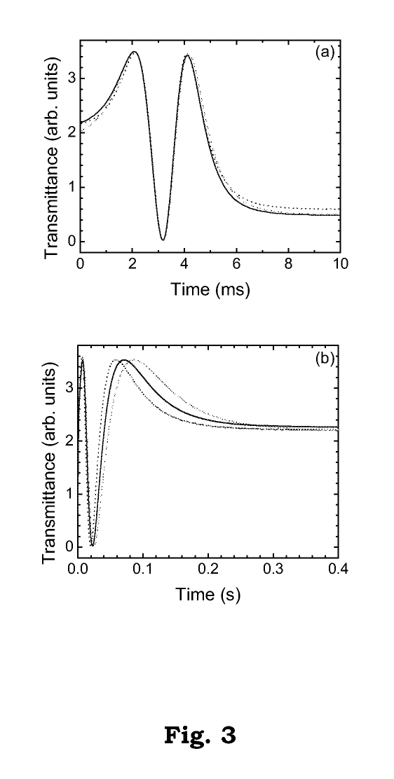

FIG. 3(a) displays the dynamic response of LC after the externally applied voltage is switched on to 6 V. While a dc voltage of 6V is applied to the cells, the LC molecules are aligned into the steady quasi-homeotropic state and the darker state is obtained. Each time-evolved transmittance curve during the response time mimics the shape of the voltage-dependent transmittance as shown in FIG. 1. Note that the rise and decay times of a planar-aligned LC display cell may be given by the mathematical expression

t_{switching}∝γ₁d²/ε₀ΔεV²−π²K₁₁ (7)

where γ₁ is the rotational viscosity. As π²K₁₁ is very small compared with ε₀ΔεV², the rise time and decay time are given mainly by Tᵣᵢₛₑ ∝γ₁d²/ε₀Δε V² and Tdecay ∝ γ₁d²/K¹¹, respectively. One can see from FIG. 3a that, because the rise time is strongly dependent on the switching voltage V(>>Vₜₕ), little difference exists between the response curves corresponding to the undoped and doped cells. FIG. 3(b) depicts the dynamic response of LC relaxation, which is measured as transmittance vs. time after the dc voltage is switched off. The relaxation curves between the distinct LC cells are clearly distinguishable. Obviously, a carbon-nanosolid additive slows down the relaxation process. It is known that the concentration of dichroic dyes for guest-host LC displays is often very low to avoid the increase of γ₁. It is reasonable to suspect that the CNT doping increased the rotational viscosity in the nematic system. However, its minute amount (˜0.01% by weight) would result in very limited amendment of the viscosity as well as the viscoelastic coefficient γ₁/K₁₁. Indeed, our transient-current experiment mentioned above led to the rotational viscosity of the CNT (0.05 wt %) suspension of 0.039 Pa·s, a value comparable to that of pristine E7 of 0.035 Pa·s. One should be reminded that the optical decay time is proportional to (γ₁/K₁₁)d² for strong anchoring (W→∞) while it is proportional to (γ₁d/2W for a weak-anchoring boundary condition. Because the relaxation time constants of the neat and nanotube-doped nematic cells are only slightly different, no readily apparent evidence is found for an appreciable reduction of anchoring energy due to considerable modification (if any) of the LC/polyimide interface by doping with CNTs.

### EXAMPLE 2

As mentioned in the Prior Art, the degradation in display performance is primarily caused by the adsorbed ions on the alignment layers. The adsorbed ionic layers, named electric bilayers, create strong internal electric fields in the regions adjoining the alignment layers, affecting the director orientation of NLCs and resulting in polar surface interactions. To explain the motion of charges in NLC cells, theoretical and experimental investigations on the transient current in differently prepared samples induced by various forms of applied voltages were reported. A peak of transient current resulting from a step voltage in a cell without the alignment layers was observed and the origin of the peak has been discussed on the basis of the space-charge-limited current, which is caused by injection of charges into the NLC layer from the electrodes. However, the transient-current phenomenon of a NLC cell with alignment layers is explained more completely by the double-layer effect and asymmetry in the transient depletion-layer fields, which arise from a difference in mobility of the positive and negative charges. In a polarity-reversed field, transient currents originate from the spatial distribution of carrier mobility, which is dependent on the director orientation in NLCs and on the electric double-layer thickness. The effect of the impurity ions is particularly manifested through the behavior of transient discharging current and in the double-pulse experiment. It is important to know the adsorption process, the motion of the ionic impurity and the ion-charge concentration in the NLC cell and these characteristics can be understood by measuring the transient current in the cell induced by a polarity-reversed voltage pulse applied to the cell.

The commercially available NLC mixture E7 (from Merck), whose dielectric anisotropy Δε=13.1 at 1 kHz, bulk resistivity ρ=2.4×10¹¹ Ω·cm was employed in this study. The nematic films in doped cells were impregnated with a minute addition of either highly purified SWCNTs or highly purified MWCNTs (extract containing 90%-95% nanotubes, of which 90% uncapped at both ends) as a dopant (0.05 wt %). Prior to their dispersion and ultrasonication in E7, carbon nanotubes were pretreated with a Wig-L-Bug grinding mill composed of an agate vial and two agate ball pestles. Note that grinding helped preventing aggregation or physical entanglement and shortened the length of CNTs. The well-stirred mixture was introduced into empty cells with a 5.7-μm gap by capillary action in the isotropic phase (T=60° C.). Each empty cell was manufactured with two flat glass substrates coated with indium-tin oxide (ITO). The overlapped area of the electrode patterns was 1 cm². Polyimide films were layered on the ITO glasses and rubbed in antiparallel to promote a planar alignment with a small pretilt angle (<2°). In order to discuss how the ion-charge effect in the cell is influenced by the addition of CNTs, we also prepared a reference cell composed of pristine E7.

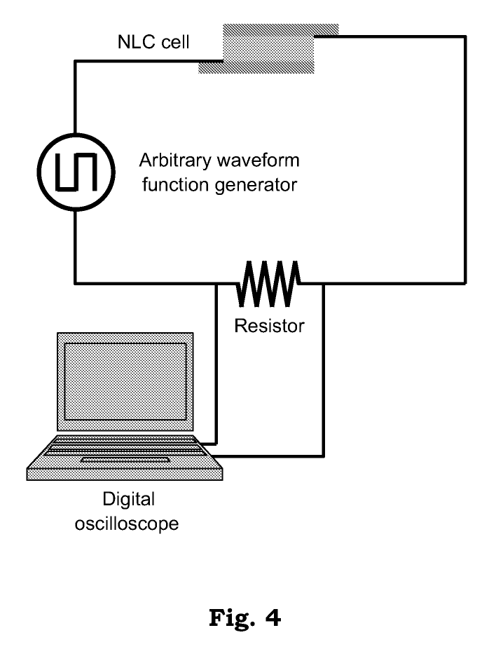

The experimental setup is displayed in FIG. 4. Due to the high resistivity of E7, transient current must be measured through a series resistor of 1 MΩ. A digital oscilloscope (Hitachi VC-5810, with the horizontal and vertical resolutions of 10 ns and 20 μV, respectively) was used to record the signal of transient current in the room temperature. The external voltage resembling a signum function from −5 to 5 s was applied across the cell thickness by an arbitrary waveform function generator (Tektronix AFG310).

### Results

Upon the onset of the polarity reversal of applied voltage, the temporal length of prefield, t, influences the transient behavior of liquid-crystal molecules, in that the prefield modifies the charge distribution, which, in turn, alters the distribution of the internal electric field. In a zero applied voltage, negative charges adsorbed form symmetrically internal electric fields, adjoining the surfaces between the alignment layers and liquid crystal layer. Under application of the prefield, the mobilized positive and negative ion charges in the cell start moving toward opposite directions and create another internal electric field that counteracts the applied voltage. One can expect that the longer duration of prefield will enhance the internal electric field and influence the orientation of NLC molecules. In brief, the effective electric field across the cell is reduced by the existence of internal electric field, which is generated by mobilized and immobilized adsorbed charges. Assume that the z axis is taken as normal to the substrates located at z=+d/2 and z=−d/2 and that the director orientation is influenced by the effective electric displacement varying merely with z. The net electric displacement in NLCs subjected to a polarity-reversed field V can be described as the following:

D(z)=ε₀εV/d±σexp(−d+2z/2L_{d})−ρ₀[1−exp(−t/τ_{d})], (8)

where ε₀ is the permittivity of free space; ε is expressed as ε=ε_{∥} sin² θ(z, t)+ε_{⊥} cos² θ(z,t); d is the cell gap; σ is the immobilized negative charge density adsorbed by alignment layers, L_{d} represents the thickness of the layer of diffused charges compensating the surface adsorbed charges, ρ₀ is the diffusion charge density, and τ_{d} is the diffusion time of positive and negative charges. Note that τ_{d}=d²e/μkT, where e is the elementary charge, μ is the average charge mobility, k is the Boltzmann constant, and T is the temperature of the cell. It exhibits that the effective electric displacement is primarily dominated by the amount of adsorbed charge density, diffusion charge density and diffusion length. In order to study the transient behavior of current across the cell, one needs to know the spatial distribution of the director orientation θ(z) as a function of the position along the direction normal to the substrates. For simplicity, the boundary later model was adopted in the present study. The spatial distribution of the director orientation is expressed as

ln [θ(z)/θ₀]=−z/ξ(z), (9)

where θ₀ is the pretilt angle (˜2° in the study), and ξ(z) is the electric coherence length and is written as ξ(z)²=[K/(ε₀ΔεE(z)²)] (where K is an average modulus in the equal elastic constant approximation, and E(z)=D(z)/ε_{eff}). In our numerical calculation, the film thickness is divided into 1000 divisions to confirm that it is much smaller than ξ(z). The steady distribution of director orientation can be calculated by using Eqs. (8) and (9) and can be written as

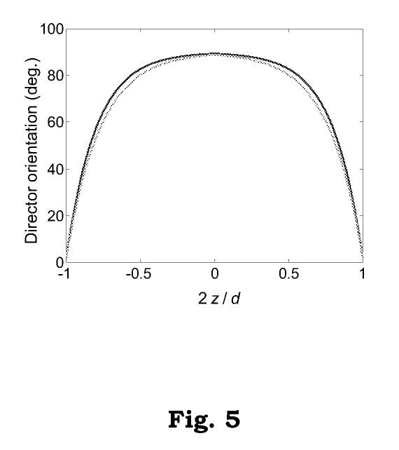

θᵢ=θᵢ₋₁exp(−z/ξᵢ₋₁ (10)

where the subscripts i and i−1 indicate the adjacent discrete positions in the cell. FIG. 5 is the simulations of the spatial distribution of the director orientation in the pristine E7 cell with ρ₀˜10⁻⁵ C/m², σ˜1.56 C/m², L_{d}=0.217 μm and τ_{d}=2.8 s which have been calculated in our recent study. It displays, as the polarity reversal of an applied voltage takes place from the negative (solid line) to positive (dashed line), that the director reorients abruptly, causing the change in either effective dielectric constant or charge mobility and then inducing a transient current in the cell.

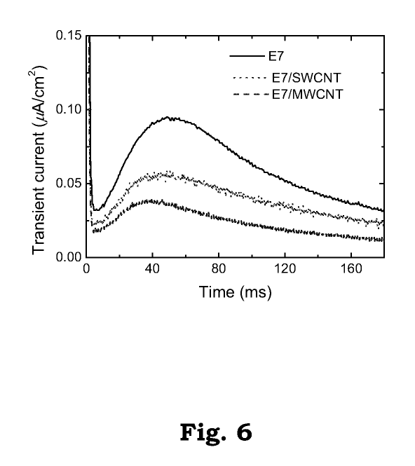

The experimental results of transient current of neat E7, E7/SWCNT and E7/MWCNT cells in a polarity-reversed voltage from −1 V to +1 V are illustrated in FIG. 6. One can see that, upon the onset of the polarity reversal, the normal charging current appears within about 100 μs, followed by a transient-current peak. Voltage dependence of the peak current Iₚ which is directly extracted from the transient-current measurements at various V is displayed in FIG. 4. The Relationships between Iₚ and V are expressed as Iₚ˜V^{1.2}, Iₚ˜V^{1.4} and Iₚ˜V^{1.5} for the E7, E7/SWCNT and E7/MWCNT cells, respectively. It should be noted that the behavior of Iₚ in each cell cannot be explained by the Child-Langmuir law based on the space-limited current.

The relationship between the peak current and the applied voltage is dictated by the thickness of the adsorbed bilayers, which is dominated by the amount of the adsorbed charge on the substrate surfaces and by the cell gap and modifies the distribution of electric field in the regions between the alignment layers and LC layer. Due to the fixed cell gap in this study, the double-layer effect, causing the resulting transient current to be stronger as shown in FIG. 6, is enhanced by the higher density of the adsorbed charge in the neat cell. In contrast, for the both doped cells exhibiting a relatively low peak current at a given voltage, this figure implies that the density of adsorbed charge is decreased by the dopant. In addition, the MWCNTs as a dopant have better ability to reduce more effectively the adsorbed-charge density than SWCNTs do. Now that the effective double-layer thickness becomes thinner and the internal electric field becomes weaker in the doped cells, the NLC molecules in E7/MWCNT or E7/SWCNT cell would experience a relatively higher effective external field for the same dc voltage applied. This consequence adds to the subsequent lowering of the driving voltage due to the increased effective dielectric constant. The similar phenomena were observed in our recent study of the electro-optical properties of twisted-nematic liquid crystal cell. It shows that SWCNTs and MWCNTs dramatically lower the dc driving voltage and suppress the hystereses of optical transmittance and electric capacitance arising from the ion contamination of the cells.

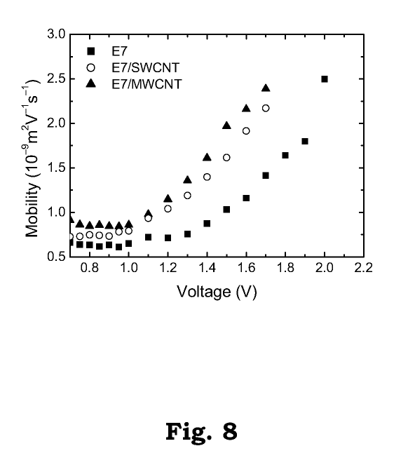

In a zero field, the planar-aligned configuration of the cell is confirmed by the alignment layers which indicates that the charge mobility μ along the normal direction of substrates equals to the magnitude of the charge mobility perpendicular to the liquid-crystal director, μ_{⊥}. Increasing the applied voltage (>>Vₜₕ), the orientation texture of the nematic director becomes a homeotropic one and most NLC molecules become roughly parallel to the field direction so that the order of charge mobility will agree with the values of mobility along the LC director, μ_{∥}. The voltage-dependent mobility is depicted in FIG. 8 by using μ=d²/tₚV, where tₚ is the time when the transient current reaches the peak value, d is the cell thickness and V is, again, the applied voltage. This figure exhibits that, for a given voltage, the mobility in a doped cell is higher, certainly due to carbon-nanotube doping to the E7 cell. Note that SWCNTs as a dopant can be semiconducting or metallic, depending on their geometric structure including helix and diameter, but most MWCNTs are metallic. From the distinct electric property of SWCNTs with respect to MWCNTs, one can expect that the values of mobility and dielectric anisotropy of the MWCNT-doped cell are higher than those of the SWCNT-doped cell.

There are several reasons being able to explain why the higher bulk mobility is observed in the CNT-doped cells. Firstly, it is presumably attributed to the vertical alignment of the one-dimensional high-aspect-ratio carbon nanotubes induced by the applied field and to the parallel orientations of the NLC director and the highly elongated nanotubes.

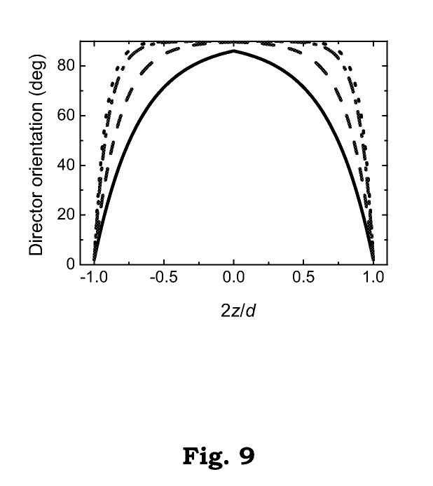

Secondly, because the MWCNTs as a dopant have the ability to suppress the charge density and enhance the diffusion length, which have been roughly calculated from the experimental results of polarity-reversed transient current in MWCNT-doped cell, the director tilt in the MWCNT-doped E7 cell is larger than that in the pristine E7 cell. Again, using Eqs. (8)-(10), the spatial distribution of the director orientation is obtained, as shown in FIG. 9. Note that, in order to exhibit how the internal electric field influences the director orientation in the cell, the condition of large applied voltage is assumed in FIG. 6. It displays that, even for high applied voltage, the larger director tilt in CNT-doped E7 cells, in comparison with that in neat E7 cells, is still observed, in that the adsorbed charge density is decreased by doping MWCNTs into the E7 cell. For MWCNTs as a dopant dispersed in the NLCs, theoretical calculation, based on the continuum interaction and the anchoring strength between the cylindrical particles and nematic, implies that the nematic director tends to align in parallel to the long axis of MWCNTs. But, the orientation of SWCNTs is more difficult to decide due to the complicated intermolecular interactions and entropic ordering effect between NLCs and SWCNTs. Although the stable orientation of the anisometric particle's major axis in nematics has yet to be proven, vivid evidence from our earlier studies of voltage-dependent capacitance and this study show that E7 molecules anchor in parallel to the long axis of SWCNTs and MWCNTs. Under the application of an electric field, the orientation of the NLC director and long axes of SWCNTs and MWCNTs follow the field direction through elastic (and continuum) interaction.

In the above examples, the experimental results of transient current in the doped cell exhibit that the values of the transient-current peaks are reduced by carbon nanotubes incorporated into the NLC host, implying that the carbon-nanotube additives decrease the ion-charge concentration. We also observe that the charge mobilities in SWCNT- and MWCNT-doped cells are larger than that in the neat cell. The promoted mobility observed in doped cells is attributed to the fact that the carbon nanotubes align themselves in parallel to the electric field.

Obviously many modifications and variations are possible in light of the above teachings. It is therefore to be understood that within the scope of the appended claims the present invention can be practiced otherwise than as specifically described herein. Although specific embodiments have been illustrated and described herein, it is obvious to those skilled in the art that many modifications of the present invention may be made without departing from what is intended to be limited solely by the appended claims.

What is claimed is:

1. A liquid crystal composite comprising:
a liquid crystal composition as a host;
a plurality of carbon nanotubes as dopants dispersed in the liquid crystal composition, wherein the average length of the carbon nanotubes is equal to or less than 1 μm.

2. The liquid crystal composite according to claim 1, wherein the liquid crystal composition comprises calamitic liquid crystal.

3. The liquid crystal composite according to claim 1, wherein the carbon nanotubes are single-walled, double-walled or multi-walled carbon nanotubes (CNTs).

4. The liquid crystal composite according to claim 1, wherein the carbon nanotubes are at a concentration equal to or less than 0.1 wt % of the liquid crystal composite.

5. The liquid crystal composite according to claim 1, wherein the carbon nanotubes are at a concentration equal to or less than 0.05 wt % of the liquid crystal composite.

6. The liquid crystal composite according to claim 1, wherein more than 80% of the carbon nanotubes are dispersed at nanoscale level.

7. A liquid crystal device comprising:
a first electrode;
a second electrode, at least one of the first and second electrodes being transparent; and
a liquid crystal composite disposed between the electrodes, comprising (a) a liquid crystal composition as a host; (b) a plurality of shortened carbon nanotubes as dopants dispersed in the liquid crystal composition, wherein the average length of the shortened carbon nanotubes is equal to or less than 1 μm.

8. The liquid crystal device according to claim 7, wherein the average length of the shortened carbon nanotubes decreases with decreasing the distance between the first and second electrodes.

9. The liquid crystal device according to claim 7, wherein the distance between the first and second electrodes ranges from 10 μm to 150 μm, the average length of the shortened carbon nanotube is equal to or less than 1 μm.

10. The liquid crystal device according to claim 7, wherein the distance between the first and second electrodes is equal to or less than 10 μm, the average length of the shortened carbon nanotube is equal to or less than 500 nm.

11. The liquid crystal device according to claim 7, wherein the distance between the first and second electrodes is equal to or less than 5 μm, the average length of the shortened carbon nanotube is equal to or less than 200 nm.

12. The liquid crystal device according to claim 7, wherein the carbon nanotubes are single-walled, double-walled or multi-walled carbon nanotubes (CNTs).

13. The liquid crystal device according to claim 7, wherein the shortened carbon nanotubes are at a concentration equal to or less than 0.1 wt % of the liquid crystal composite.

14. The liquid crystal device according to claim 7, wherein the shortened carbon nanotubes are at a concentration equal to or less than 0.05 wt % of the liquid crystal composite.

16. The liquid crystal device according to claim 7, wherein more than 80% of the shortened carbon nanotubes are dispersed at nanoscale level.

17. The liquid crystal device according to claim 7, wherein the liquid crystal device is selected from the group consisting of a display device, a spatial light modulator, a wavelength filter, a variable optical attenuator (VOA), an optical switch, a light valve, a color shutter, a lens and lens with tunable focus.

18. The liquid crystal device according to claim 7, wherein the liquid crystal device is a display device, which is a direct addressing, a multiplexed, or an active matrix type TN (twisted nematic), HAN (hybrid-aligned nematic), VA (vertical alignment), planar nematic, STN (super-TN), optically compensated bend (OCB), TFT-TN mode liquid crystal display, or an IPS (in plane switching) mode or FFS (fringe field switching) mode liquid crystal display.

19. The liquid crystal device according to claim 7, wherein a method for forming the liquid crystal composite comprising:
providing a plurality of carbon nanotubes;
performing a grinding process to shorten the carbon nanotubes, so that the average length of the shortened carbon nanotubes is equal to or less than 1 μm;
adding the shortened carbon nanotubes into the liquid crystal composition to form a mixture; and
performing an agitation process to agitate the mixture to form the liquid crystal composite.

20. The method according to claim 19, wherein the grinding process uses ball mills or roller mills.

21. The method according to claim 19, wherein the grinding process uses a Wig-L-Bug grinding mill.

22. The method according to claim 21, wherein the Wig-L-Bug Grinding Mill comprises a vial and two ball pestles, and the material of the vial and two ball pestles is selected from the following group consisting of: zirconia, silicon nitride, agate.

23. The method according to claim 19, wherein the agitation process uses an apparatus selected from the group consisting of a high speed mixer, homogenizer, microfluidizer, a Kady mill, a colloid mill, a high impact mixer, an attritor, an ultrasonic bath, a ball and pebble mill, and combinations thereof.
